(19) United States
(12) Patent Application Publication
(10) Pub. No.: US 2010/0040354 A1
(43) Pub. Date: Feb. 18, 2010

(54) DEVICE AND METHOD FOR COLLECTING AERIAL IMAGES AND DATA FROM A LIGHT TRANSPORTABLE MANNED AERIAL VEHICLE

(76) Inventor: Norman Becerra, La Habra, CA (US)

Correspondence Address: ADVANTIA LAW GROUP, 9035 SOUTH 1300 EAST, SUITE 200, SANDY, UT, 84094, US

(21) Appl. No.: 12/353,830

(22) Filed: Jan. 14, 2009

Related U.S. Application Data
(60) Provisional application No. 61/020,807, filed on Jan. 14, 2008.

(51) Int. Cl. G03B 39/00

(52) U.S. Cl. 396/13

(57) ABSTRACT

A method and device for collecting aerial images and data. There is: an aircraft device, configured to fly through the air, including: a retractable mounting member, configured to extend and retract; and a pan tilt mounting member, configured to pan in a horizontal axis and tilt in a vertical axis, coupled to the retractable mounting member opposite the aircraft device. There is also: a data collecting device housing, coupled to the pan tilt mounting member opposite the retractable mounting member, configured to house a data collecting device; and a data collecting device, configured to collect images and data, disposed within the data collecting device housing. The data collecting device includes a remote control system in wireless communication with the data collecting device.

### CROSS-REFERENCE TO RELATED APPLICATIONS

This invention claims priority, under 35 U.S.C. §120, to the U.S. Provisional Patent Application No. 61020807 to Becerra filed on 14 Jan. 2008 which is incorporated by reference herein.

### BACKGROUND OF THE INVENTION

1. Field of the Invention

The present invention relates to recording devices and methods, specifically recording devices and methods for recording images and data from aircraft.

2. Description of the Related Art

In the related art, aircraft, or light transportable manned aerial vehicles, are often used to record images and data of the Earth from the air or space. Several types of aircraft, such as airplanes and helicopters, are equipped with cameras and other recording devices to collect images and data from the air. For example, military spy planes frequently include cameras for collecting data over hostile territory. In the same way, satellites orbiting the Earth often capture aerial images and data of the Earth and space, such as images of the polar ice caps and hurricane routes.

However, it is often difficult to collect data from aircraft as the mechanics of the aircraft tend to interfere with the quality of the data collected. For instance, turbulence often results in unclear, fuzzy, or shaken images. Moreover, traditional cameras and data recording instruments often cannot stand up to exposure to environmental elements such as rain, snow, extreme heat, and extreme cold.

Also, it is often unsafe and/or difficult for pilots to collect data while also piloting the aircraft as the pilots various tasks and responsibilities may interfere with one another. For example, pilots may be too busy operating the aircraft to collect images and data. Likewise, pilots may be unsafe by collecting images and data, rather than focusing on operating of the aircraft. Such actions are particularly unsafe when the pilot has to maneuver around or through hazards such as trees, mountains, telephone poles, and no-fly zones.

Some improvements have been made in the field. Examples of references related to the present invention are described below, and the supported teachings of each reference are incorporated by reference herein:

U.S. Pat. No. 4,752,791, issued to Allred, discloses an improved nose mount that permits smooth and accurate pan and tilt of the camera by remote control and also provides an effective means for reducing to a minimum the vibration of a motion picture of TV camera mounted on a helicopter or other platform. The camera mount includes an open rectangular frame depended from the aircraft and shocked braced therefrom; a first inner mount of open form gimbaled to the frame about a vertical axis and an inner camera mount gimbaled to the first mount about a horizontal axis. The camera mount is shock mounted to the inner mount. Separate drive motors are provided for the two axes and a remote control and display are provided inside the cockpit. The camera mount is roll-stabilized to keep it level during turns of the helicopter.

U.S. Pat. No. 4,825,232, issued to Howdle, discloses a removable adaptor mount for receiving a camera-carrying gimbal beneath an aircraft with has a base plate with a clamp for removably engaging the diagonal wing strut. An anchor on the base spaced from the strut clamp can be secured to the wing. Holes on the base permit a convention gimbal to be bolted to the mount.

U.S. Pat. No. 5,426,476, issued to Fussell et al., discloses an aircraft video camera mount provides for the removable, temporary attachment of a video camera and associated tilt and pan mechanisms to the upper end of the wing strut of a high wing airplane, or alternatively to a suitable strut of another aircraft type. The strut attachment bracket secures around the strut at one end, and may bolt through the strut at the opposite end using the existing wing tiedown bolt hole normally provided through the wing strut. The camera tilt, pan, and focal length are remotely operated by an operator in the aircraft. Both the electrical power and the operating systems for the camera are preferably portable and self contained, so they may be easily removed and quickly installed in the aircraft as the need arises, thus precluding the need for FAA approvals for use of the existing aircraft electrical or other systems to operate the present camera system. The device is particularly suited to news operations where a dedicated aircraft is not available at all times, and/or where the additional expense of specialized aircraft (e.g., helicopters and blimps) is not justified. With the present device, an existing fixed wing aircraft may be used for charter or other operations when not need for aerial video photography, due to the ease and quickness of installation and removal of the present camera equipment.

U.S. Pat. No. 5,710,945, issued to Thompson, discloses a camera mounting mechanism is attachable to a helicopter to support and isolate an exterior camera against vibrational forces generated by the helicopter during flight maneuvers. Individual shock absorbers are arranged in a ring pattern around a central axis of the mounting mechanism to absorb the vibrational forces.

U.S. Pat. No. 5,752,088, issued to Desselle, discloses an aerial photography device. The device includes a blimp filled with lighter than air gas or some other structure which will keep the device aloft. The device will also include a servo platform for positioning and moving the aerial photography device in the air and camera platform. Both the servo platform and the camera platform are attached to a servo frame, which in turn is attached to the blimp. The camera platform has a camera mount which is pivotable about at least one axis of rotation. A remote transmitter and a receiver mounted on the device allow an operator to remotely control the servo platform and the camera platform.

However, such aircraft are often bulky and unfit for safe manual operation and/or piloting, particularly during takeoff and landing. In addition, the recording devices of the aircraft are often difficult to use. Similarly, the range of view for recording is often limited by such aircraft. Finally, such aircraft and recording devices are often expensive and difficult to manufacture.

What is needed is a device and method for recording aerial images and data that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available recording devices and methods. Accordingly, the present invention has been developed to provide a device and method for collecting aerial images and data from a light transportable manned aerial vehicle.

In one embodiment of the invention, there may be a device for collecting aerial images and/or data. The device may include: an aircraft device, which may be configured to fly through the air, which may include: a retractable mounting member, which may be configured to extend and/or retract; and/or a pan tilt mounting member, which may be configured to pan in a horizontal axis and/or tilt in a vertical axis, which may be coupled to the retractable mounting member opposite the aircraft device; and/or a data collecting device housing, which may be coupled to the pan tilt mounting member opposite the retractable mounting member, which may be configured to house a data collecting device; and/or a data collecting device, which may be configured to collect images and/or data, which may be disposed within the data collecting device housing.

The data collecting device may also include a remote control system which may be in wireless communication with the data collecting device. The aircraft device may be a paraglider, a hangglider, and/or an ultralight. The data collecting device may be a digital camera.

In another embodiment of the invention, there may be a method for collecting aerial images and/or data, which may include: activating an aircraft device, which may be configured to fly through the air; extending a retractable mounting member, which may be configured to extend and/or retract, which may be coupled to the aircraft device, and/or including: a pan tilt mounting member, which may be configured to pan in a horizontal axis and/or tilt in a vertical axis, which may be coupled to the retractable mounting member opposite the aircraft device; and/or a data collecting device housing, which may be coupled to the pan tilt mounting member opposite the retractable mounting member, which may be configured to house a data collecting device; and/or a data collecting device, which may be configured to collect images and/or data, which may be disposed within the data collecting device housing; activating the data collecting device from a location remote to the aircraft device; and/or collecting images and/or data from the data collecting device.

The method may further include activating the data collecting device from the aircraft. The method may also include retracting the retractable mounting member. The method may additionally include panning the pan tilt mounting member in a horizontal axis. In addition, the method may include tilting the pan tilt mounting member in a vertical axis.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a front perspective view of a device for collecting aerial images and data, according to one embodiment of the invention; and

FIG. 2 illustrates a flowchart of a method for collecting aerial images and data, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

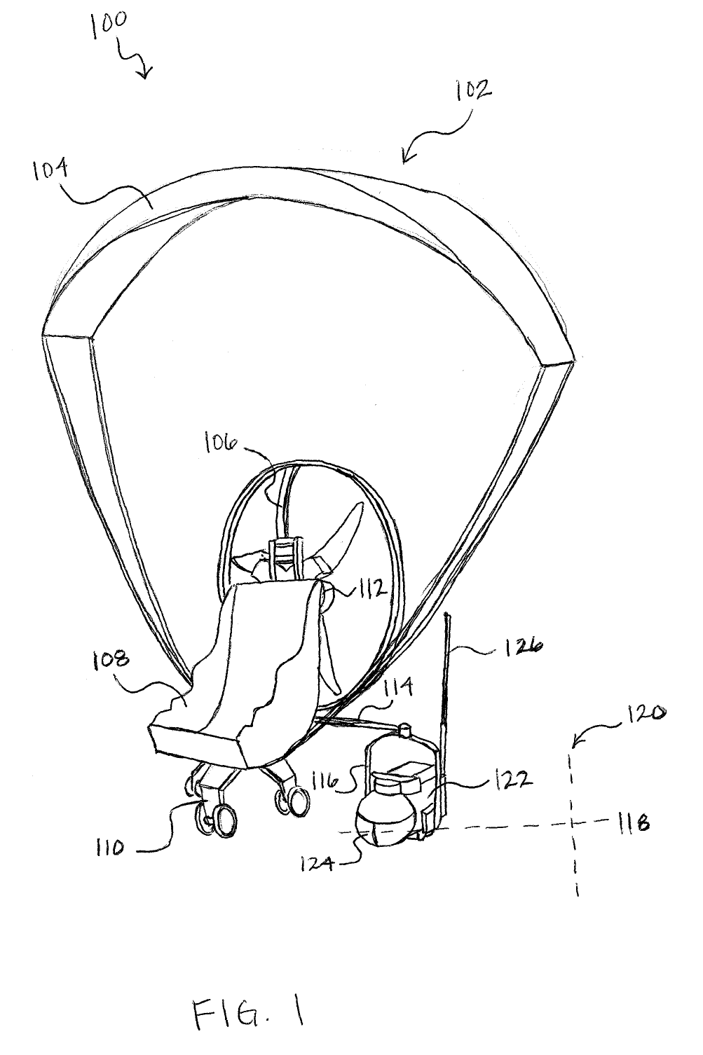

FIG. 1 illustrates a device for collecting aerial images and data 100, including a light transportable manned aerial vehicle, or aircraft device, 102. As illustrated, the aircraft device 102 is configured to fly through the air, and includes a wing 104, a frame 106, a seat 108, landing gear 110, and a motor 112. Accordingly, one skilled in the art would understand that the aircraft device 102 may be a paraglider, such as the inflatable structure paraglider of U.S. Pat. No. 5,244,169, issued to Brown et al., or the self-powered model paraglider of U.S. Pat. No. 3,204,368, issued to Effinger et al., or the motorized paraglider with automatic steering system for preventing upset of U.S. Pat. No. 6,360,991, issued to Alan, which are incorporated by reference herein.

FIG. 1 also illustrates a retractable mounting member 114, coupled to the seat 108 of the aircraft device 102. The retractable mounting member 114 is configured to extend and retract, thereby enabling extension and retraction above or below the landing gear 110 depending on which is appropriate for the phase of operation the aircraft device 102 is in; either takeoff, landing, or flight. As a result, one skilled in the art would understand that the retractable mounting member 114 may extend and retract such as the retractable landing gear of U.S. Pat. No. 2,630,990, issued to Kanode et al., which is incorporated by reference herein. Further, one skilled in the art would appreciate that the retractable mounting member 114 may also be configured to dampen vibration and adjust the center of gravity when operated by a pilot. Accordingly, one skilled in the art would understand that the retractable mounting member 114 may be such as the automatic steering system for preventing upset of U.S. Pat. No. 6,360,991, issued to Alan, which is incorporated by reference herein.

FIG. 1 further illustrates a pan tilt mounting member 116 coupled to the retractable mounting member 114. The pant tilt mounting member 116 is configured to pan at least 360 degrees in the horizontal axis 118, and tilt at least 120 degrees in the vertical axis 120. As a result, the pan tilt mounting member 116 may be such as the camera mount of U.S. Pat. No. 4,752,791, issued to Allred, which is incorporated by reference herein. Further, the pan tilt mounting member 116 may be configured to receive wireless, or radio, transmissions from a remote location for directing the pan and tilt movement. Additionally, the pan tilt mounting member 116 may be configured for operation by a pilot of the aircraft device 102. Accordingly, the pan tilt mounting member 116 may include features and functions of the remote control system of U.S. Pat. No. 5,438,362, issued to Tabuchi, which is incorporated by reference herein.

Also shown by FIG. 1, there is a data collecting device housing 122 and a data collecting device 124 coupled to the pan tilt mounting member 116. The data collecting device housing 122 may be comprised of a protective composite casing. In addition, the data collecting device housing 122 may be waterproof and vibration resistant, such as the camera mount of U.S. Pat. No. 4,752,791, issued to Allred, which is incorporated by reference herein.

In addition, one skilled in the art would understand that the data collecting device 124 may be a camera, such as the video camera capable of effecting remote control operation of U.S. Pat. No. 4,928,179, issued to Takahashi et al., incorporated by reference herein. Furthermore, the data collecting device 124 may be any camera understood in the art weighing less than 15 pounds, thereby minimizing the effect of the weight of the data collecting device 124 on the operation of the aircraft device 102.

Advantageously, the data collecting device 124 may be operated from a remote location via a remote control system 126. For example, images and/or data from the data collecting device 124 may be transmitted in real time to a pilot via an on-board monitor, or goggles, and to a remote operator, thereby enabling the pilot and camera operator to coordinate image and/or data collection. Also, removing the data collecting device operator from the aircraft device 102 provides for a greater degree of safety. Accordingly, the data collecting device 124 and its operation may be such as the proxy-based remote control method and system for a digital camera of U.S. Pat. No. 7,068,306, issued to Pyle et al., which is incorporated by reference herein.

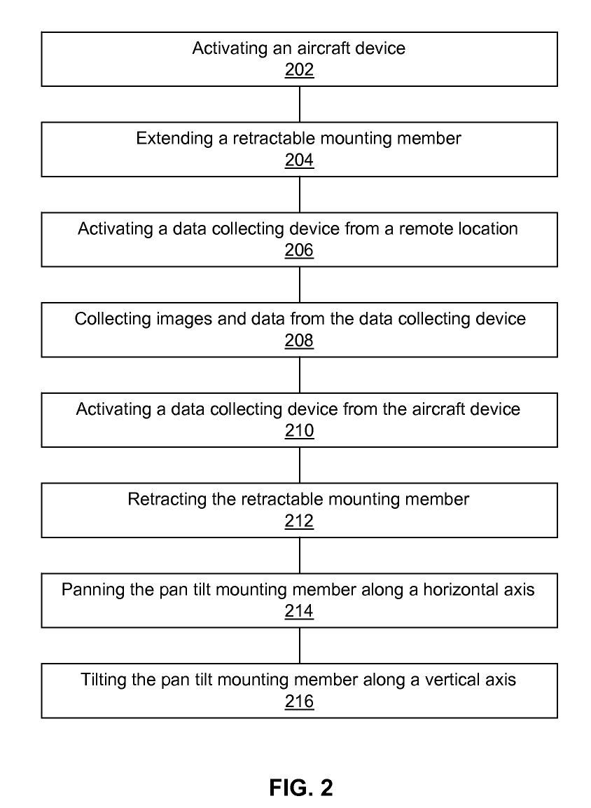

FIG. 2 illustrates a method for collecting aerial images and data. As illustrated, the method includes activating an aircraft device 202. The aircraft device may be activated by piloting the aircraft device for takeoff, flight, and landing, such as the human powered hangglider of U.S. Pat. No. 4,417,707, issued to Leong, which is incorporated by reference herein. The method also includes extending a retractable mounting member 204, which includes a pan tilt mounting member, a data collecting device housing, and a data collecting device. The retractable mounting member may be extended and/or retracted such as the retractable landing gear of U.S. Pat. No. 2,630,990, issued to Kanode et al., which is incorporated by reference herein. The method further includes activating the data collecting device from a location remote to the aircraft device 206; and collecting images and data from the data collecting device 208. The data collecting device may be activated, and images and data may be collected from the data collecting device, via a remote control system such as the proxy-based remote control method and system for a digital camera of U.S. Pat. No. 7,068,306, issued to Pyle et al., which is incorporated by reference herein.

The illustrated method further includes activating the data collecting device from the aircraft device 210. The data collecting device may be activated from/by the aircraft device for collecting aerial images and data such as the camera mount of U.S. Pat. No. 4,752,791, issued to Allred, which is incorporated by reference herein. Additionally, the method includes retracting the retractable mounting member 212, panning the pan tilt mounting member along a horizontal axis 214, and tilting the pan tilt mounting member along a vertical axis 216. The retractable mounting member and the pan tilt mounting member may be moved and operated such as the camera mount of U.S. Pat. No. 4,752,791, issued to Allred, which is incorporated by reference herein.

Accordingly, in operation of one embodiment of the invention, a pilot activates and operates all aspects of flying an aircraft device 102, including takeoff, landing, and activating and positioning a data collecting device 124 for collection of images and data from the air. The pilot also extends and retracts a retractable mounting member 114. During takeoff and landing, the data collecting device 124 is retracted and locked above landing gear 110 of the aircraft device 102 by the retractable mounting member 114. When in flight, the pilot extends and lowers the retractable mounting member 114 for collecting images and data from the air. The pilot also activates, or turns on, a pan tilt mounting member 116 for panning and tilting the data collecting device 124.

A remote data collecting device operator positions the pan tilt mounting member 116 via a remote control system 126. The remote data collecting device operator also collects images and data from the air via the remote control system 126. Further, the remote data collecting device operator may operate features of the data collecting device 124, such as, but not limited to: zoom, focus, iris control, and shutter speed. The pilot additionally collects images and data with the data collecting device 124. For example, the data collecting device 124 may be operated by the on-board electrical system of the aircraft device 102 with a battery powered back-up.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a light transportable manned aerial vehicle 102, one skilled in the art would understand that any aircraft device 102 may be used. For instance, one skilled in the art would understand that aircraft devices 102 such as, but not limited to, airplanes and helicopters may be used to collect images and data from the air.

It is also envisioned that any data collecting device 124 may be used to collect, or record, images and data. For example, it is envisioned that any camera appreciated in the art may be a data collecting device 124. Similarly, one skilled in the art would understand that the data collecting device 124 may be configured to collect any data understood in the art, such as, but not limited to, video images and/or data, sound data, still images and/or data, photographs, and/or infrared imaging.

It is expected that there could be numerous variations of the design of this invention. One example is that the light transportable manned aerial vehicle 102 may include a seat and/or a harness for a passenger.

Finally, it is envisioned that the components of the device 100 may be constructed of a variety of materials. For example, the components of the device for collecting aerial images and data 100 may be comprised of materials such as, but not limited to: metal, rubber, plastic and/or glass.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A device for collecting aerial images and data, comprising:
a) an aircraft device, configured to fly through the air, including:
a1) a retractable mounting member, configured to extend and retract; and
a2) a pan tilt mounting member, configured to pan in a horizontal axis and tilt in a vertical axis, coupled to the retractable mounting member opposite the aircraft device; and
b) a data collecting device housing, coupled to the pan tilt mounting member opposite the retractable mounting member, configured to house a data collecting device; and
c) a data collecting device, configured to collect images and data, disposed within the data collecting device housing.

2. The device of claim 1, wherein the data collecting device includes a remote control system in wireless communication with the data collecting device.

3. The device of claim 1, wherein the aircraft device comprises a paraglider.

4. The device of claim 1, wherein the aircraft device comprises a hangglider.

5. The device of claim 1, wherein the aircraft device comprises an ultralight.

6. The device of claim 1, wherein the data collecting device comprises a digital camera.

7. A method for collecting aerial images and data, comprising:
a) activating an aircraft device, configured to fly through the air;
b) extending a retractable mounting member, configured to extend and retract, coupled to the aircraft device, and including:
b1) a pan tilt mounting member, configured to pan in a horizontal axis and tilt in a vertical axis, coupled to the retractable mounting member opposite the aircraft device; and
b2) a data collecting device housing, coupled to the pan tilt mounting member opposite the retractable mounting member, configured to house a data collecting device; and
b3) a data collecting device, configured to collect images and data, disposed within the data collecting device housing;
c) activating the data collecting device from a location remote to the aircraft device; and
d) collecting images and data from the data collecting device.

8. The method of claim 7, further comprising the step of activating the data collecting device from the aircraft.

9. The method of claim 8, further comprising the step of retracting the retractable mounting member.

10. The method of claim 9, further comprising the step of panning the pan tilt mounting member in a horizontal axis.

11. The method of claim 10, further comprising the step of tilting the pan tilt mounting member in a vertical axis.

12. A device for collecting aerial images and data, comprising:
a) an aircraft device, configured to fly through the air, including:
a1) a retractable mounting member, configured to extend and retract; and
a2) a pan tilt mounting member, configured to pan in a horizontal axis and tilt in a vertical axis, coupled to the retractable mounting member opposite the aircraft device;
b) a data collecting device housing, coupled to the pan tilt mounting member opposite the retractable mounting member, configured to house a data collecting device; and
c) a data collecting device, configured to collect images and data, disposed within the data collecting device housing; and
d) a remote control system in wireless communication with the data collecting device.

13. The device of claim 12, wherein the aircraft device comprises a paraglider.

14. The device of claim 12, wherein the aircraft device comprises a hangglider.

15. The device of claim 12, wherein the aircraft device comprises an ultralight.

16. The device of claim 12, wherein the data collecting device comprises a digital camera.
